(19) United States
(12) Patent Application Publication
(10) Pub. No.: US 2006/0053166 A1
(43) Pub. Date: Mar. 9, 2006

(54) Method and apparatus/software to determine, to represent and to display the state of progress and remaining risk while performing a planned course of action

(76) Inventors: Donald V. Steward, Napa, CA (US); Stuart S. T. Williams, Fair Oaks, CA (US)

Correspondence Address: Donald V. Steward, 1000 Banbury Court, Napa, CA, 94558, US

(21) Appl. No.: 10/938,886

(22) Filed: Sep. 9, 2004

(51) Int. Cl. G06F 17/00

(52) U.S. Cl. 707/104.1

(57) ABSTRACT

Method and its software that helps one choose assumptions needed to solve problems or manage projects and manage their risks. Throughout the process the software helps one track through time what assumptions have been confirmed as correct, what assumptions are ready to be confirmed, and what assumptions are not yet ready to be confirmed. It also shows what work has been done that is not subject to any unconfirmed assumptions, what work has been done using assumptions that have not been confirmed, and what work is yet to be done. Software uses a matrix showing what information items depend on what others,

### CROSS REFERENCE TO RELATED APPLICATIONS [None|TBD]

### BACKGROUND OF INVENTION

The present invention relates to a method for evaluating progress and remaining risk while carrying out a planned course of action called a project. The project may be broken down into the execution of tasks. Some tasks may need to be performed before others, and some tasks can be performed at the same time other tasks are being performed. The usual measure of progress is based on making estimates for how long it would take to perform each of the tasks and comparing the time it took to do the tasks that have been performed with how long it would take both to do the performed tasks and the tasks that have not yet been performed. Such a measure might be used in conjunction with critical path scheduling.

However, many tasks may require the use of assumptions for information that will not be available until certain other tasks will be performed until later. When that information does become available, it may become evident that the assumptions were not adequate, making it necessary to make new assumptions and repeat some or all of the tasks that depended on the prior assumptions, repeating this process until the adequacy of the assumption is verified. A good measure of progress should distinguish between the completion of tasks that have been done and do not rely on any still unverified assumptions and tasks that have been done that do rely on assumptions that have not yet been verified. When this distinction is not made, the estimate of progress and remaining risk can be very distorted.

In measuring progress the amount that a task that has been done but is still dependent on one or more verified assumptions should be weighted by the likelihood that it will not be necessary to redo it. Thus, a task performed that still depends on one or more open assumptions should not be counted as fully as a task performed that does not depend on any assumptions or other items that depend on assumptions.

Risks are caused by not knowing whether assumptions that are used now may turn out later to be wrong. The time and cost to carry out the whole process will depend on whether or not these assumptions are correct.

Planning and scheduling a project in the past has been done by working with tasks, their durations, and dependencies between tasks that require that some tasks be done before certain others can be started and some tasks can be done concurrently. This planning is restricted to dealing with tasks and time, which does not reveal the relations between the various pieces of information that that are needed. The effect of these information relations is assumed in making the plan and might not be recognized. Assumptions must be made about information that will not be available until later. These assumptions are not evident while dealing only with tasks and time as is done now.

It is common that risks and progress are not properly estimated with the result that there is a great surprise when it is finally realized that some assumption is wrong, and the money or time necessary to redo the work that was based on the wrong assumption is no longer available. Then the project is considered failed because of some combination of the project going over the planned budget, going over the planned time, or not meeting the requirements.

Definitions

Dependency Structure Method—also known as the Design Structure Matrix, is a method used to analyze the dependencies between items to define a procedure/project that will resolve these items. The Dependency Structure Method works primarily with information dependencies as distinct from time dependencies. Dependencies between items can involve circuits. To make a plan which occurs over a period of time, the circuits must be broken by using assumptions now for items that will not be determined until later. This process is repeated until the assumptions used for an item are consistent with the later determination of that item.
Project—The effort to determine all the items necessary to define a design or solution to a problem.
Item—Something that must be resolved before the project can be considered complete, usually a piece of information or a task that produces a piece of information.
Determined Item—an item for which its result has been determined.
Resolved Item—An item that has been determined or established without being subject to any open assumptions.
Assumption—A guess made for one item before it is determined.
Verified Assumption—An assumption about an item that has been determined to be appropriately consistent with all the other items on which it depends.
Open Assumption—An assumption that has not yet been verified.
Closed Assumption—An assumption that has been verified.
Ready Task—A task for which the non-assumed items on which it depends have been determined.
Adequate Assumption—An assumption for an item that has been declared adequately consistent with its use as assumptions.
Depends on—One item depends on another item when the determination of the second item is needed to determine the first item.
Perform—As in perform a task.
Task—Some element of work that can be performed over time and can be determined as to whether it is ready to begin or has been completed.

### SUMMARY OF INVENTION

This invention makes it possible during the course of carrying out a project to see what assumptions have been made during the planning, to see when these assumptions can be tested later to determine whether they can be declared consistent with the assumptions used for them, to keep track of what assumptions at that point in time have been verified, and to keep track of what tasks that have been performed depended on unverified assumptions and thus may have to be redone if those assumptions later prove to be inadequate.

This invention is based on the Dependency Structure Method (DSM) for solving problems. DSM is not part of the present invention. DSM starts by listing all the items of information that must be resolved before the problem can be considered to have been solved. Then a spreadsheet is made with marks in cells to show for each item what other items directly affect it. For the purpose of describing this patent, the convention is used that a mark in a cell in the spreadsheet indicates that the item represented by the row of this mark is directly affected by the item represented by the column of this mark. It is further assumed that the items always occur in the same order in both the rows and the columns. The diagonal will be considered as running from the top left to the bottom right such that the marks on the diagonal would correspond to an item affecting itself.

Using these conventions and assuming that the items were to be determined in the order they appear in the rows, a mark in a cell to the left of the diagonal indicates that the when the item of its row is determined that the item of its column has already been determined. A mark in a cell to the right of the diagonal indicates that the item of its column has not yet been determined. Thus, whenever there is a mark in a cell to the right of the diagonal, determining the item of its row requires using an assumption for the item of its column.

Reordering the rows and their corresponding columns will change which marks appear to the left of and to the right of the diagonal. Partitioning is a process that is part of DSM which reorders the rows and their corresponding columns so that all the marked cells to the right of the diagonal occur within square blocks on the diagonal and such that these square blocks can be no smaller and still contain all the marked cells to the right of the diagonal.

In this configuration a mark to the right of the diagonal for which the item of its column has not been finished the use of an open assumption. An open assumption represents a risk that has not yet been resolved.

A mark to the right of the diagonal indicates that to resolve the item of its row it is necessary to use an assumption for the item of its column. When the item of its column is later resolved, one can review whether the assumptions used for that item were appropriate. If not appropriate, a new assumption is made and this assumption remains open until it can be verified. Once it is verified, this assumption is closed.

At any time during a project each item is in one of six states: The state of each item at any time during the project is defined by two sets of labels.

Label Set 1:
1. Never worked on.
2. Being worked on for the first time, but not finished.
3. Being worked on again subsequent to the first time it was worked on, but not yet finished.
4. Finished subject to no assumption that has not been verified.
5. Finished but subject to one or more assumptions that have not been verified

Label Set 2: In addition, an item labeled 4 or 5 in label set 1 may also be given a label (either a or b) to indicate whether at least one assumption had been used for determining this item or for any other item that was used to determine this item.
a. One or more open assumptions or other items that still depend on open assumptions had been used to determine this item.
b. No assumption has been used to determine this item or any other item on which it depends.

Thus each item falls into one of these states: 1, 2, 3, 4a, 4b, 5a, 5b.

One can display a sense of the risk that remains by distinguishing in some way the marks that correspond to assumptions that are still open. One can also distinguish between items that have been resolved subject to no open assumptions and those items that have been determined but are still affected by open assumptions.

### DESCRIPTION OF FIGURES

These figures describe an example of a possible implementation of the present invention.

The colors in the figures used to distinguish the states of the items are as follows:
Color A (dark green in this example)—FINISHED—Item has been determined and its determination did not involve the use of any open assumptions or any other items that are subject to any open assumptions. That is, its determination is final.
Color B (dark blue in this example)—READY—All the other items needed to determine this item, other than assumptions that are shown to the right of the diagonal, are available for this item's determination
Color C (red in this example)—ASSUMPTIONS BEING USED—Color for marks showing where assumptions are necessary to determine the item in the row of an item being determined.
Color D (light green in this example)—RESOLVED SUBJECT TO OPEN ASSUMPTIONS—The item has been resolved but is still assumptions used directly for this item or used by any item on which it depends, directly or indirectly, that does depend on any outstanding assumption.
Color E (lavender in this example)—BEING DETERMINED AGAIN—being determined again subsequent to its first determination because the item could not be verified from prior determinations.
Color F (plum in this example)—being determined again subsequent to its first determination.
Color G (orange in this example)—A color applied to the diagonal to indicate that the item of its row has been determined and is ready to be compared with the assumptions that had been used for this item.

FIG. 1: Shows a possible implementation of a representation of how the items of information that must be determined before a problem can be declared to be solved depend on each other. X's mark the diagonal. Marks, in this instance, 0's, are entered into a spreadsheet to show where the item corresponding to the row depends directly on the item corresponding to the column. The construction of such a spreadsheet or matrix in part of the DSM technique and is not part of the present invention.

FIG. 2: Shows the same spreadsheet as in FIG. 1 with its rows and corresponding columns reordered in the same way so that for each item of information represented by a row, the marks to the left of the diagonal in that row represent the dependency of said item on other items that will be available when said item is to be determined, and the marks to the right of the diagonal represent items of information that will not be available when said item is determined, thus requiring that assumptions for the column items be used to determine the row item. Different symbols may be used for the various marks. What symbols are used for what marks is part of the DSM technique and is not part of the present invention.

FIG. 3: Shows the item(s) (1 through 4) that have been determined by using a distinctive color A (dark green). The item(s) (5) that is/are ready to be performed because the only item it/they depend on (1) has been already been determined.

FIG. 4: Shows marks in color C (red) where assumptions are used to determine the item(s) in color B (dark blue).

FIG. 5: Shows in color D (in this example light green) item(s) (6) that has/have been determined that depend on open assumptions, and in color B (dark blue) the item(s) (7) that is/are now ready to be determined, and in color C (red) the marks that show the assumptions that are used.

FIG. 6: Shows in color D (light green) other item(s) (7) that is/are ready to be determined, the uses of assumptions used to determine it in color C (red). When this last item(s) (7) is determined, its value can be compared with the values that were assumed for it when determining other item(s) (6). This is indicated by marking the diagonal with color G (orange).

FIG. 7: Shows in color E (lavender) the item(s) (6 & 7) that must be determined again with new assumptions because the newly determined item did not adequately compare with the assumptions that were used for it.

FIG. 8: Shows in color F (plum) item(s) (6) that has/have been determined subsequent to the first time it was determined.

FIG. 9: Shows FIG. 8 where the diagonal is marked with color G (orange) to indicate that the row item has been determined and can be used to compare it to its assumption(s) as used by other item(s) (6).

FIG. 10: Shows items (6 & 7) that have been determined such that each is consistent with the any assumptions made for it to determine other items. Thus the mark(s) that had shown that this assumption was open (row 6, column 7) no longer colored to indicate it/they is/are still open. The marks showing the dependencies of these items on other still open assumptions remain color C (red).

FIG. 11: Shows where another item has been resolved in color D (light green) and that it can now be compared to the assumptions that were used for it.

FIG. 12: Shows that item(s) (9) that have been determined have resulted in confirming the assumptions made for those item(s). Therefore those items that previously depended on these assumptions for these item(s) can now consider that these assumptions are closed. Where these marks had been colored C (red), that color has been removed.

FIG. 13: Shows that an item (8) when determined failed to demonstrate that the assumptions previously used for it were adequate. Therefore, the marks showing this dependence return to color C (red).

FIG. 14: Shows that certain item(s) (6-9) have been determined again and are now in conformance with their use(s) as assumptions. Thus, the marks representing the use of these items lose their color C (red).

FIG. 15: Shows that now certain items (6-9) have been shown to be consistent with their use as assumptions. Thus the marks showing the use of these items as assumptions have their color C (red) removed.

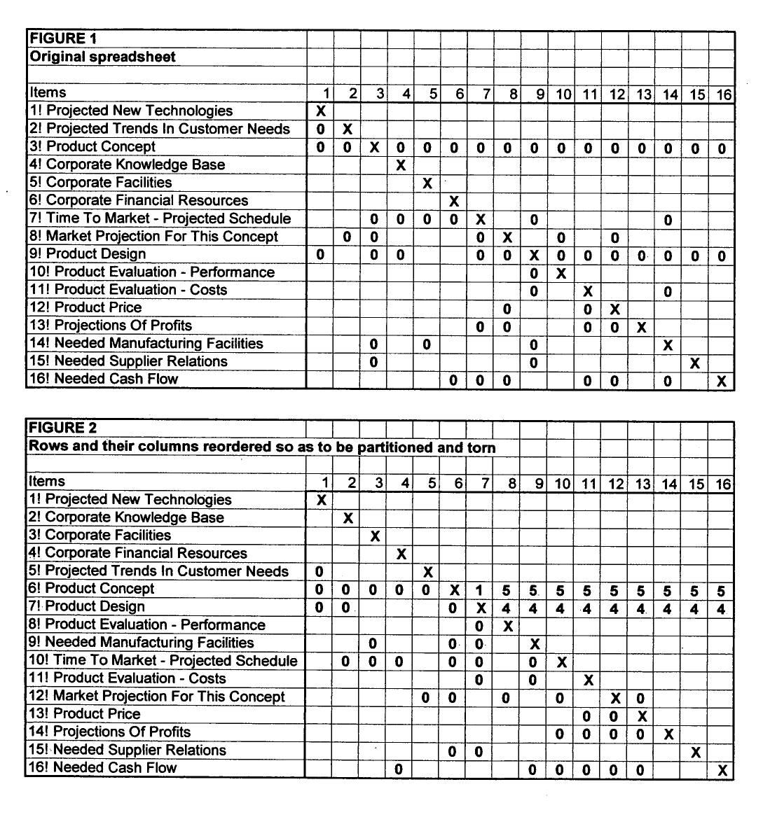

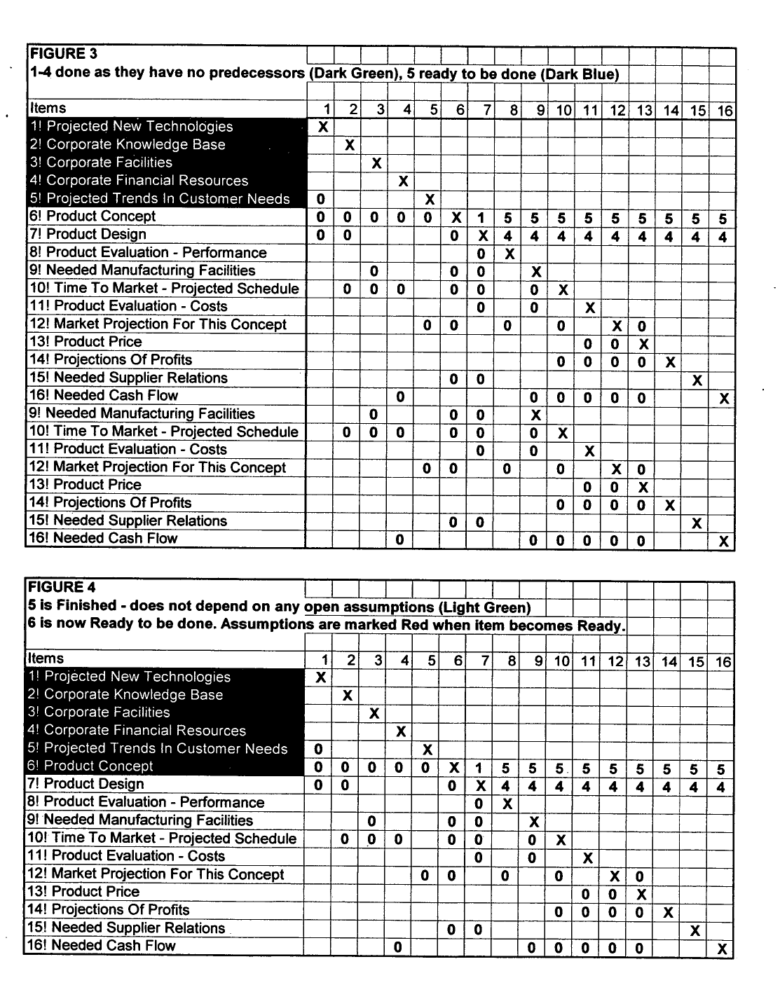

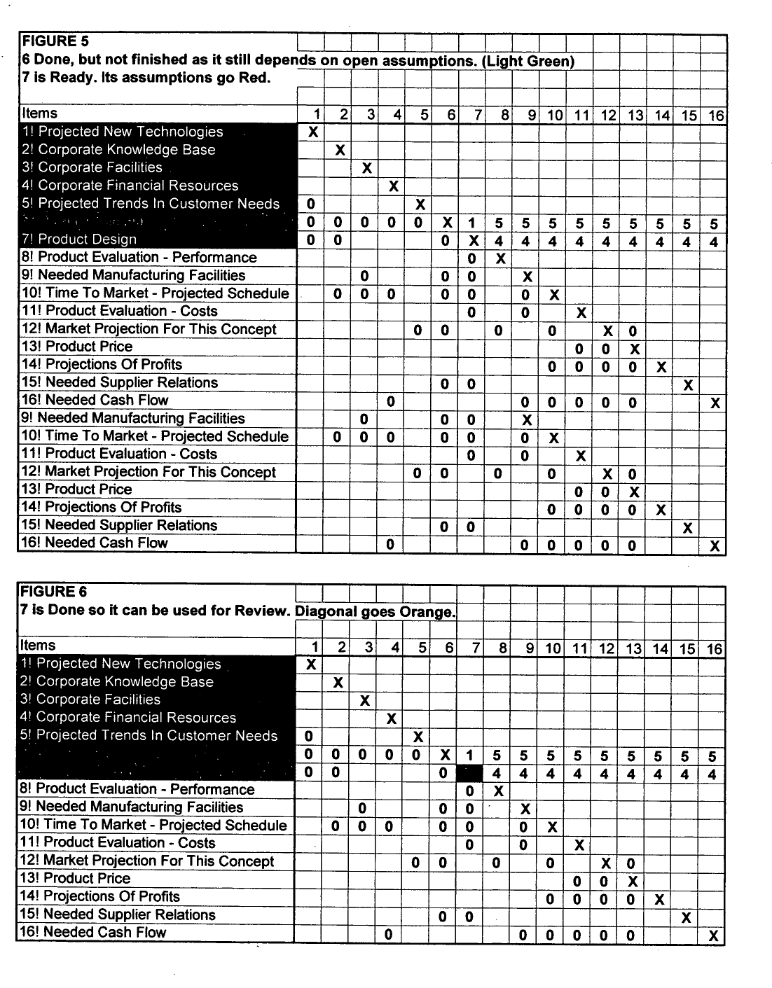

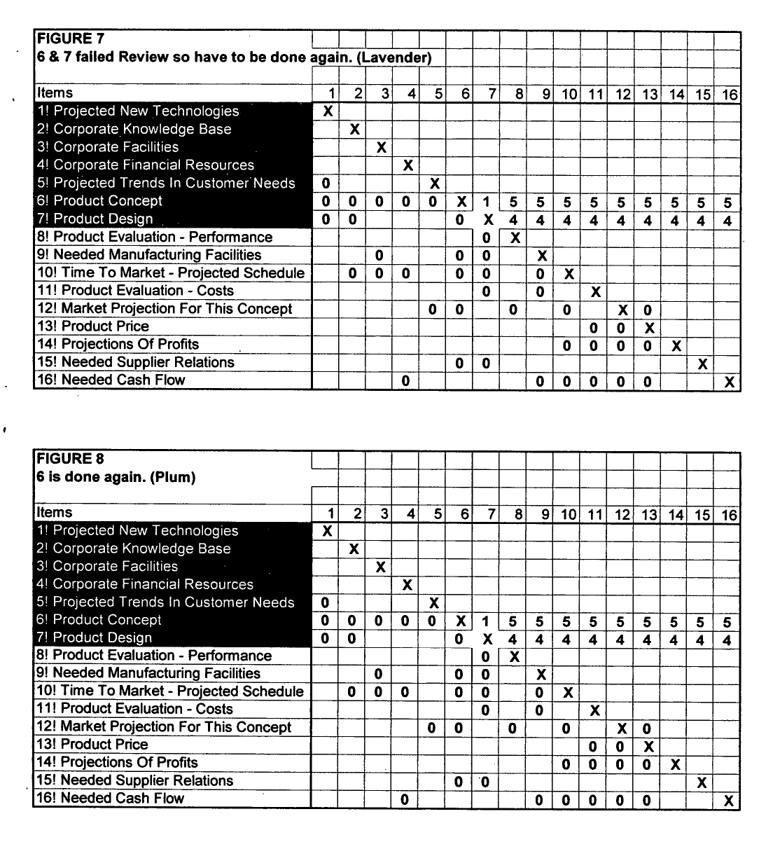

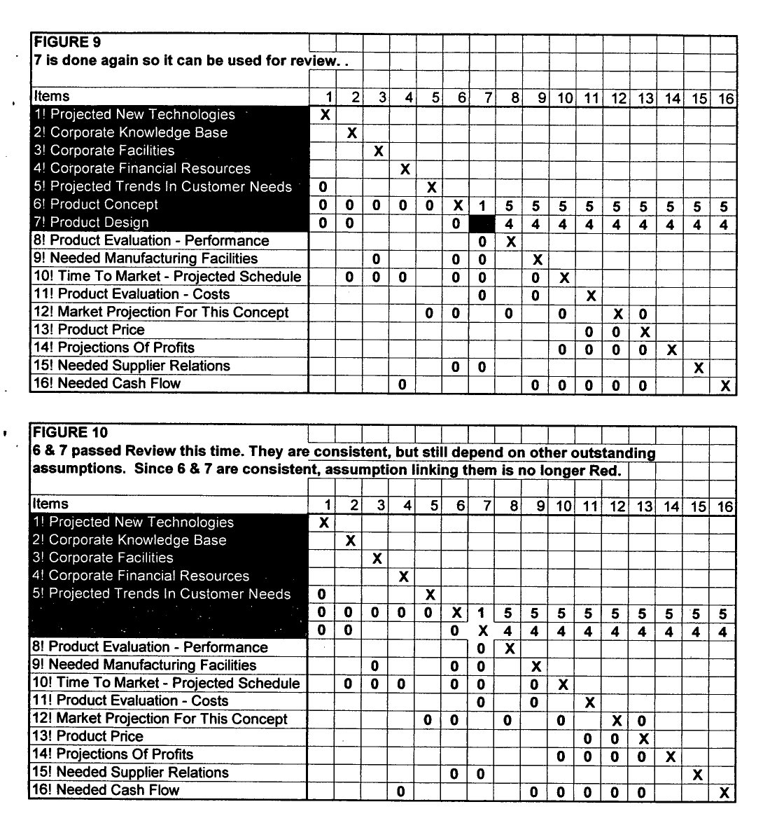

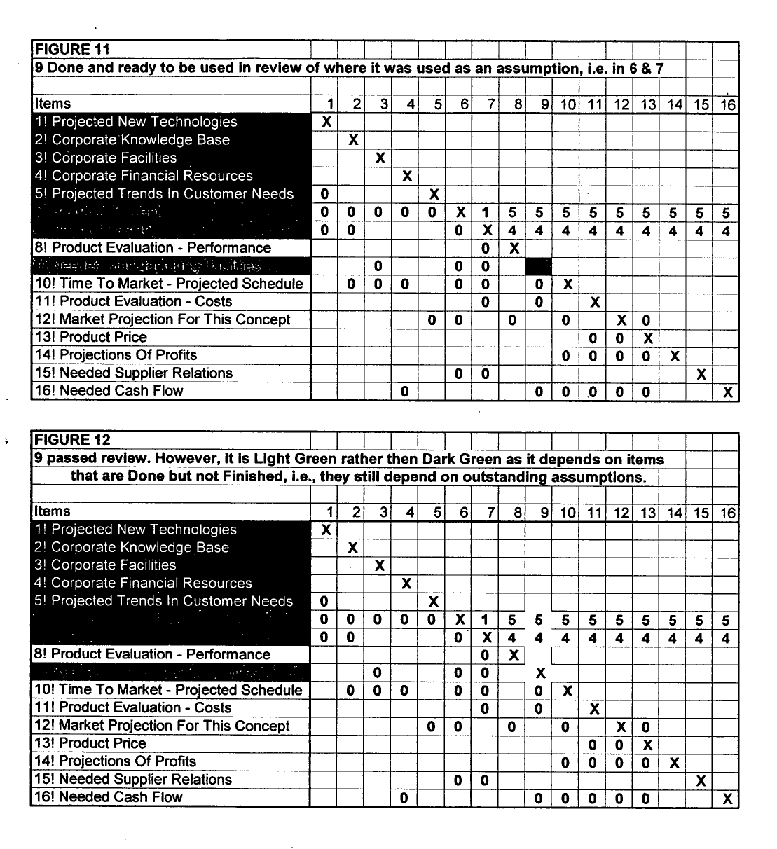

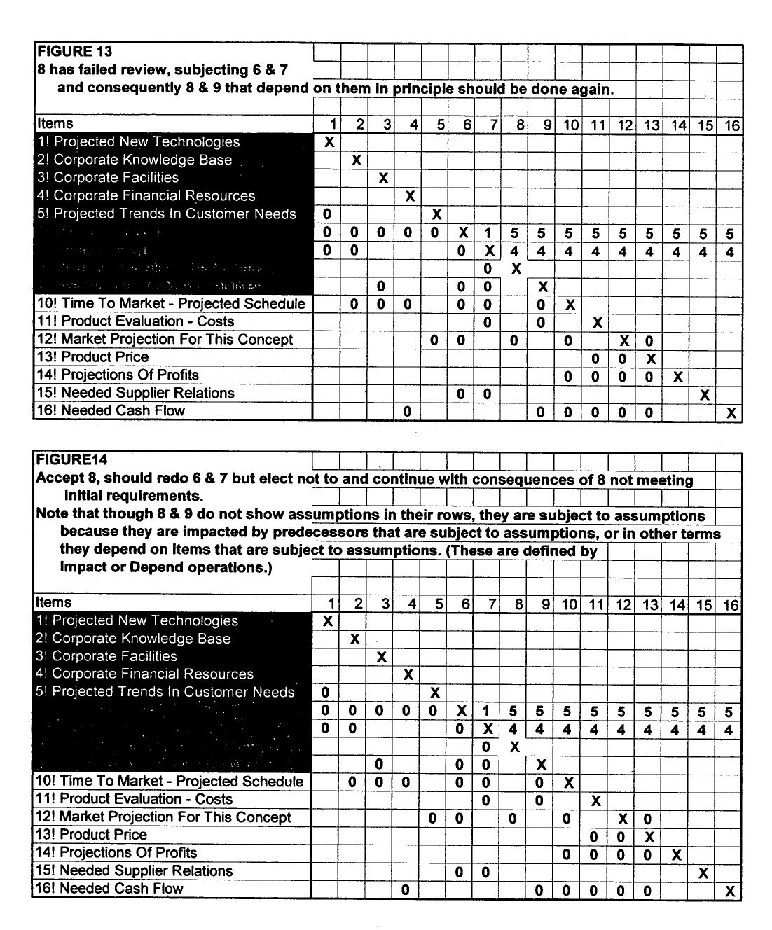

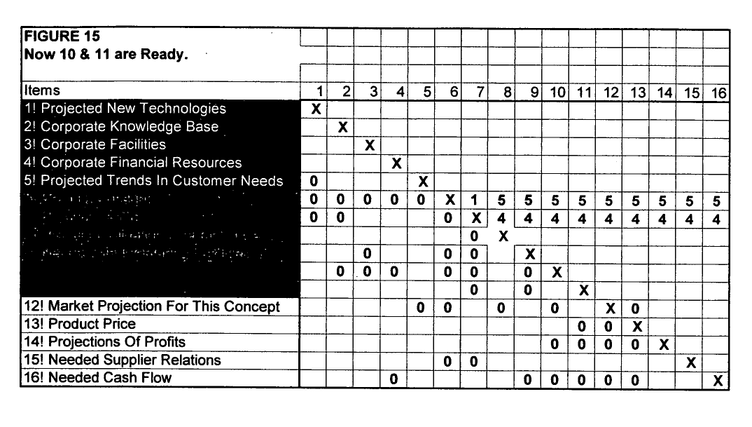

I claim:

1. A method for determining, representing and displaying the state of what assumptions have been used by indicating at each point in time during the course of a project where an open assumption is used and where a closed assumption has been used.

2. A method for determining, representing and displaying the state of a task at each point in time during the course of a project by showing whether the task has not been worked on (Color A) or is being worked on (Color B), or has been completed using open assumptions, or has been completed without using any open assumptions.

3. A method for determining, representing and displaying the state of progress by making distinctions between tasks that have been perform using assumptions that are still open and tasks that have been performed without using any assumptions that are still open.

4. A method for determining, representing and displaying when new information becomes available to allow comparisons to be made between the new information and the assumptions that had been made for that information.
